(19) United States
(12) Patent Application Publication
(10) Pub. No.: US 2020/0318395 A1
(43) Pub. Date: Oct. 8, 2020

(54) Handcuff Securing Device

(71) Applicant: CUFFSECURE LLC, Niceville, FL (US)

(72) Inventors: John Lee, Niceville, FL (US); Robert Cutter, Owings, MD (US); Ronald Pierce, Owings, MD (US); Shawn Teets, Niceville, FL (US)

(21) Appl. No.: 16/372,501

(22) Filed: Apr. 2, 2019

(51) Int. Cl. E05B 75/00

(52) U.S. Cl. CPC E05B 75/00

(57) ABSTRACT

A method of restraining a person with a handcuff assembly comprises providing a handcuff assembly comprising a pair of handcuffs and a securing cord, the securing cord comprising a connector at each opposing end. The method further comprises applying the pair of handcuffs on the wrists of a person, looping the cord through an opening positioned proximal to the waist of the person and releasably connecting each connector of the securing cord to each handcuff to prevent or limit the handcuffs from being moved from the back side of the person to the front side of the person.

### TECHNICAL FIELD

The present invention is related to the field of personal restraining devices, and more specifically to a handcuff securing device that augments handcuffs of the kind normally used by law enforcement personnel in the line of duty.

### BACKGROUND

An important task performed by law enforcement personnel is the handcuffing of a person and the subsequently transporting the person safely to an intended destination. Experience has shown that handcuffs alone may not be adequate to keep a handcuffed person such as a suspect secure and safe. Several instances have been recorded wherein handcuffed persons have managed to move the handcuffed hands from behind the back of the person to the front of the person undetected by law enforcement personnel. After such a maneuver, often the persons have subsequently gone on to physically hurt themselves, the law enforcement personnel and others; such actions have occasionally resulted in fatal injuries.

Opportunities exist for reducing the risk posed by the ability of a handcuffed person to move the handcuffed hands from behind the back of the person to the front of the person.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Disclosed herein is a handcuff assembly comprising a pair of handcuffs and a securing cord. The securing cord comprises a connector at each opposing end, with each connector configured for releasably connecting to a handcuff. The cord is configured for looping through an opening positioned proximal to the waist of a person wearing the pair of handcuffs, wherein looping the cord through the opening limits or prevents the handcuffs from being moved from the back side of the person to the front side of the person.

According to one or more embodiments, the connector comprises an interlocking spring snap.

According to one or more embodiments, the connector comprises a threaded quick link.

According to one or more embodiments, the cord comprises a nylon kernmantle material.

According to one or more embodiments, the cord has a minimum breaking strength of approximately 550 pounds.

According to one or more embodiments, the cord has a maximum elongation of approximately 40%.

According to one or more embodiments, the connector includes a sleeve enclosing at least a portion of connector surface.

According to one or more embodiments, the connector is connected to the cord by a clamping means.

According to one or more embodiments, the clamping means includes one or more threaded fasteners and a sealant for sealing the fastener threads.

According to one or more embodiments, the connector comprises a number combination lock of at least two digits.

According to one or more embodiments, the cord includes a metallic cable core.

Disclosed herein is a method of restraining a person with a handcuff assembly. According to one or more embodiments, the method comprises providing a handcuff assembly comprising a pair of handcuffs and a securing cord. The securing cord comprises a connector at each opposing end. The method further comprises applying the pair of handcuffs on the wrists of a person and releasably connecting each connector of the securing cord to each handcuff after looping the cord through an opening positioned proximal to the waist of the person to prevent or limit the handcuffs from being moved from the back side of the person to the front side of the person.

According to one or more embodiments, the connector comprises an interlocking spring snap.

According to one or more embodiments, the connector comprises a threaded quick link.

According to one or more embodiments, the cord comprises a nylon kernmantle material.

According to one or more embodiments, wherein the cord has a minimum breaking strength of approximately 550 pounds.

According to one or more embodiments, the cord has a maximum elongation of approximately 40%.

According to one or more embodiments, the connector includes a sleeve enclosing at least a portion of connector surface.

According to one or more embodiments, the connector is connected to the cord by a clamping means.

According to one or more embodiments, the clamping means includes one or more threaded fasteners and a sealant for sealing the fastener threads.

Disclosed herein is a method of restraining a person with a handcuff assembly. The method comprises providing a handcuff assembly comprising a pair of handcuffs and a securing cord, the securing cord comprising a connector at each opposing end; applying the pair of handcuffs on the wrists of a person; and, looping the cord through an opening positioned proximal to the waist of the person and releasably connecting each connector of the securing cord to each handcuff to prevent or limit the handcuffs from being moved from the back side of the person to the front side of the person.

### BRIEF DESCRIPTION OF THE DRAWINGS

The foregoing, as well as the following Detailed Description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 is a schematic structural diagram of a handcuff securing device according to one or more embodiments of the present invention.

FIG. 2 is a schematic structural diagram of a handcuff assembly that includes the handcuff securing device of FIG. 1 as worn by a person according to one or more embodiments of the present invention.

FIG. 3 is another schematic structural diagram of the handcuff assembly that includes the handcuff securing device of FIG. 1 as worn by a person according to one or more embodiments of the present invention.

### DETAILED DESCRIPTION OF THE EMBODIMENTS

Below, the technical solutions in the examples of the present invention are depicted clearly and comprehensively with reference to the figures according to the examples of the present invention. Obviously, the examples depicted here are merely some examples, but not all examples of the present invention. In general, the components in the examples of the present invention depicted and shown in the figures herein can be arranged and designed according to different configurations. Thus, detailed description of the examples of the present invention provided in the figures below are not intended to limit the scope of the present invention as claimed, but merely represent selected examples of the present invention. On the basis of the examples of the present invention, all of other examples that could be obtained by a person skilled in the art without using inventive efforts will fall within the scope of protection of the present invention. The present invention will be further described with reference to the accompanying drawings:

As noted earlier, experience has shown that handcuffs alone may not be adequate to keep a handcuffed suspect secure and safe. Several instances have been recorded wherein handcuffed suspects have managed to move the suspects' handcuffed hands from behind the back of the suspect to the front of the suspect undetected by law enforcement personnel. After such a maneuver, often the suspects have subsequently gone on to physically hurt themselves, the law enforcement personnel and others; such actions have occasionally resulted in fatal injuries. Court systems and jails may use belly chains and other devices to secure suspects and prisoners; however, such devices may not be practical for law enforcement personnel performing their duties in the streets.

Embodiments of the presently disclosed subject matter can advantageously reduce the risk posed by the ability of a handcuffed suspect to move the handcuffed hands from behind the back of the suspect to the front of the suspect.

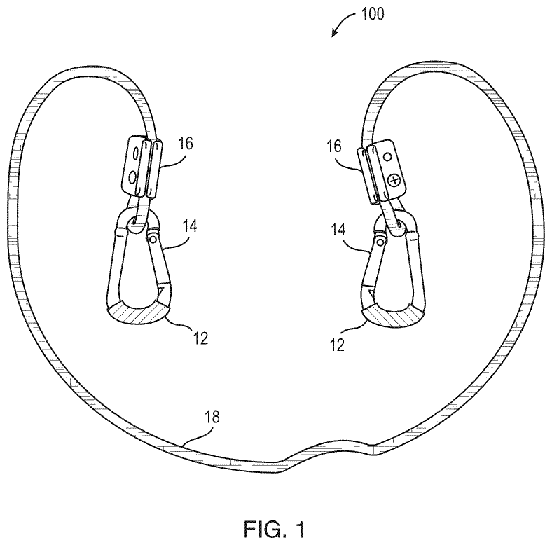

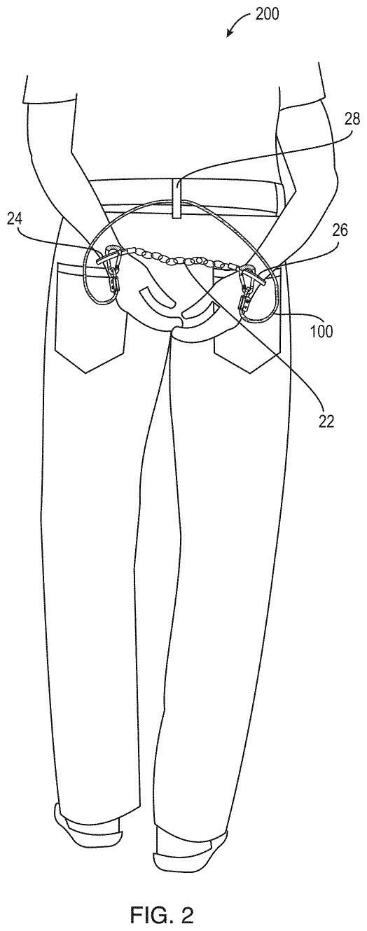

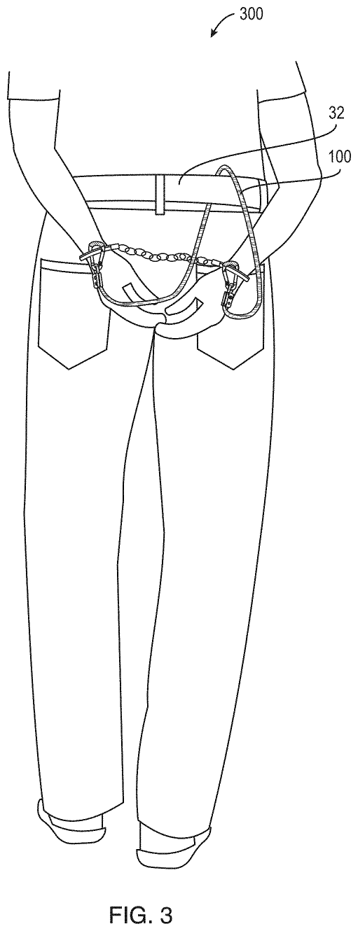

FIG. 1 illustrates handcuff securing device 100 according to one or more embodiments of the present invention. FIG. 2 illustrates handcuff assembly 200 comprising a pair of handcuffs 22 and handcuff securing device 100 as applied to a person or as worn by a person, according to one or more embodiments of the present invention. FIG. 3 illustrates handcuff assembly 300 comprising a pair of handcuffs 22 and handcuff securing device 100 as applied to a person or as worn by a person, according to one or more embodiments of the present invention.

As shown in FIG. 1, handcuff securing device 100 includes a pair of connectors 14, cord 18, and a pair of clamps 16 securing cord 18 to connectors 14. Further, as shown in FIG. 1, each connector 14 can include sleeve 12 covering at least a portion of the surface of connector 14. Sleeve 12 can work to prevent metal on metal contact between connector 14 and left and right cuffs 24, 26 (see left and right cuffs 24, 26 shown in FIG. 2) of pair of handcuffs 22 (see handcuffs 22 shown in FIG. 2).

FIG. 2 illustrates an embodiment of applying handcuff assembly 200 to a person. In the FIG. 2 embodiment, pair of handcuffs 22 has been applied to the wrists of a person; FIG. 2 further illustrates handcuff securing device 100 secured pair of handcuffs 22. Particularly, cord 18 is shown looped through belt loop 28 of a pair of trousers, or a similar other garment, worn by the person with one connector 14 secured to left cuff 24 and the other connector 14 secured to right cuff 26. Looping cord 18 through belt loop 28 in the manner illustrated in FIG. 2 can advantageously reduce or eliminate the risk posed by the possibility of the handcuffed person moving the handcuffed hands from behind the back of the person (as illustrated in FIG. 2) to the front of the person. In other words, the embodiment illustrated in FIG. 2 can advantageously limit or prevent the pair of handcuffs 22 from being moved from the back side of the person to the front side of the person. This in turn can advantageously help avoid the possibility of the person from physically hurting himself or herself, the law enforcement personnel and/or others that could otherwise occur if the person is able to move the handcuffs from the back side of the person to the front side of the person.

FIG. 3 illustrates handcuff assembly 300 applied to a person, according to one or more embodiments of the presently disclosed subject matter. FIG. 3 embodiment illustrates a pair of handcuffs 22 applied to the person's wrists; FIG. 3 further shows cord 18 looped through belt 32 worn by the person with one connector 14 being secured to left cuff 24 and the other connector 14 being secured to right cuff 26. Looping cord 18 (of handcuff securing device 100) through belt 32 in the manner illustrated in FIG. 3 can advantageously reduce the risk posed by the possibility of the handcuffed person moving the handcuffed hands from behind the back of the suspect (as illustrated in FIG. 3) to the front of the suspect. In other words, the embodiment illustrated in FIG. 3 can advantageously limit or prevent the pair of handcuffs 22 as applied to the person from being moved from the back side of the person to the front side of the person. This in turn can advantageously help avoid the possibility of the person from physically hurting himself or herself, the law enforcement personnel and/or others that could otherwise occur if the person is able to move the handcuffs from the back side of the person to the front side of the person.

The applying of the handcuff securing device 100 to the handcuffs 22 can be accomplished in other ways. In one embodiment, the cord is laced through the chain that connects the handcuffs prior to attaching the connectors to the handcuffs. In one embodiment, the connectors are attached to the handcuff chain rather than to the left and right handcuffs. In a further embodiment, the connectors can be attached to the center of the handcuffs at or near the hinge region of each of the handcuffs. In a furthermore embodiment, the connectors can be attached to a chain link of the handcuff chain that is located at or near the hinge region of each of the handcuffs.

In instances where there is no “looping” or “pass-through” point available in or near the waist area of the person to which the handcuff securing device is to be applied (for example, when the person is wearing a robe), the handcuff assembly can further include an attachment made of a similar material or a same material as chord 18, with the attachment encircling the person's waist, with cord 18 looping through a gap created between the encircled attachment and the backside of the person. In a further embodiment, this attachment can encircle and/or loop around the shoulders of the person to be restrained, with cord 18 looping through the encircled or looped attachment.

In an alternate embodiment, this attachment may be in the form of a belt configured for encircling the person's waist, wherein a gap created between this specifically supplied belt and the backside of the person providing the opening for the cord to loop therethrough. In other words, in this embodiment, the attachment can be in the form of a belt rather than in the form of a cord as described herein.

To apply the handcuff securing device as described herein for restraining a person, one of the connects 14 can be secured to one cuff of the pair of handcuffs applied to the person, with the other free end of cord 18 being looped through the person's back belt loop or belt area, following which connector 14 at the loose end is secured to the other cuff of the pair of handcuffs applied to the person. The handcuff assembly in general, as well as the handcuff securing device in particular, can advantageously limit or prevent the ability of the person to whom the handcuffs have been applied to from moving the handcuffed hands under the person's legs to the front of the person whereby the person can pose a threat to himself or herself or to others after such a maneuver.

As defined herein, the term “cord” can comprise a string, thread, thong, lace, ribbon, strap, tape, tie, line, rope, cable, wire, ligature, and similar other materials. In various embodiments, cord 18 can be constructed of a light weight, load bearing material. In one embodiment, cord 18 is rated for a minimum breaking strength of approximately 550 pounds. In one embodiment, cord 18 comprises a nylon kernmantle material. In one embodiment, cord 18 has a maximum elongation of approximately 40%. In one embodiment, cord 18 can include a metallic cable core. In some embodiments, the cord can be replaced by a chain or a metal cable.

In various embodiments, handcuffs as identified herein can be of the stand issue handcuff type that is typically supplied to law enforcement personnel such as police officers.

In one embodiment, for example, as shown in FIG. 1, clamps 16 secure the connectors 14 to cord 18. In one embodiment, clamps 16 are made of metal and can further include threaded fasteners and a sealant for sealing the fastener threads to thereby render the clamps tamper-proof. In some embodiments, the clamps 16 can be crimped in position thereby obviating the need for threaded fasteners. In various embodiments, clamps 16 can secure the connectors to the cord by various other means well-known in the relevant art.

In one embodiment, as illustrated in FIG. 1, the connector 14 comprises an interlocking spring snap. In other embodiments, the connector 14 can comprise a threaded quick link. In further embodiments, the connect 14 can include both an interlocking spring snap and a threaded envelope/cover that screws onto the spring snap to secure the spring snap in place. In some embodiments, the connector can comprise a number combination lock mechanism. In one embodiment, the number combination lock mechanism can include at least two digits. In one embodiment, the connector can be in the form of a combination lock. In a further embodiment, the connector can include a padlock with key. In a furthermore embodiment, the connector can be in the form of a padlock with key.

In one embodiment, sleeve 12 enclosing at least a portion of connector surface comprises leather. In another embodiment, sleeve 12 enclosing at least a portion of connector surface comprises polyurethane and/or similar other materials.

According to one or more embodiments of the disclosed subject matter, a method of restraining a person with a handcuff assembly comprises providing a handcuff assembly comprising a pair of handcuffs and a securing cord, the securing cord comprising a connector at each opposing end. The method further comprises applying the pair of handcuffs on the wrists of a person and releasably connecting each connector of the securing cord to each handcuff after the cord is looped through an opening positioned proximal to the waist of the person to prevent or limit the handcuffs from being moved from the back side of the person to the front side of the person. In an alternate embodiment, one of the connectors is connected to a first handcuff first; following this, the loose end of the cord is looped through the opening; following this, the other of the connectors is connected to a second handcuff.

According to an embodiment in which no “looping” or “pass-through” point in the person's clothing's mid-region is available (for example, if the person to which the handcuffs are being applied to is wearing a robe), the method further includes encircling an attachment such as, for example, a cord around the person's waist, with the cord then looping through a gap created between attachment and the backside of the person supplies the opening for the cord to loop therethrough. This attachment can be made of a similar material or a same material as chord 18. According to a further method, this attachment may be in the form of a belt, wherein the method further comprises encircling the attachment (i.e., the belt) around the person's waist whereby a gap created between the belt and the backside of the person supplies the opening for the cord to loop therethrough.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A handcuff assembly, comprising:
a handcuff assembly comprising a pair of handcuffs and a securing cord, the securing cord comprising a connector at each opposing end, each connector configured for releasably connecting to a handcuff,
wherein the cord is configured for looping through an opening positioned proximal to the waist of a person wearing the pair of handcuffs,
wherein looping the cord through the opening limits or prevents the handcuffs from being moved from the back side of the person to the front side of the person.

2. The handcuff assembly of claim 1, wherein the connector comprises an interlocking spring snap.

3. The handcuff assembly of claim 1, wherein the connector comprises a threaded quick link.

4. The handcuff assembly of claim 1, wherein the cord comprises a nylon kernmantle material.

5. The handcuff assembly of claim 1, wherein the cord has a minimum breaking strength of approximately 550 pounds.

6. The handcuff assembly of claim 1, wherein the cord has a maximum elongation of approximately 40%.

7. The handcuff assembly of claim 1, wherein the connector includes a sleeve covering at least a portion of connector surface.

8. The handcuff assembly of claim 1, wherein the connector is connected to the cord by a clamping means.

9. The handcuff assembly of claim 8, wherein the clamping means includes one or more threaded fasteners and a sealant for sealing the fastener threads.

10. The handcuff assembly of claim 1, wherein the connector comprises a numerical combination lock.

11. The handcuff assembly of claim 1, wherein the cord includes a metallic cable core.

12. A method of restraining a person with a handcuff assembly, the method comprising:
providing a handcuff assembly comprising a pair of handcuffs and a securing cord, the securing cord comprising a connector at each opposing end;
applying the pair of handcuffs on the wrists of a person; and
looping the cord through an opening positioned proximal to the waist of the person and releasably connecting each connector of the securing cord to each handcuff to prevent or limit the handcuffs from being moved from the back side of the person to the front side of the person.

13. The method of claim 12, wherein the connector comprises an interlocking spring snap.

14. The method of claim 12, wherein the connector comprises a threaded quick link.

15. The method of claim 12, wherein the cord comprises a nylon kernmantle material.

16. The method of claim 12, wherein the cord has a minimum breaking strength of approximately 550 pounds.

17. The method of claim 12, wherein the cord has a maximum elongation of approximately 40%.

18. The method of claim 12, wherein the connector includes a sleeve enclosing at least a portion of connector surface.

19. The method of claim 12, wherein the connector is connected to the cord by a clamping means.

20. A method of restraining a person with a handcuff assembly, the method comprising:
providing a handcuff assembly comprising a pair of handcuffs and a securing cord, the securing cord comprising a connector at each opposing end;
applying the pair of handcuffs on the wrists of a person; and
releasably connecting each connector of the securing cord to each handcuff after looping the cord through an opening positioned proximal to the waist of the person to prevent or limit the handcuffs from being moved from the back side of the person to the front side of the person.
